(19) United States
(12) Patent Application Publication
(10) Pub. No.: US 2006/0162484 A1
(43) Pub. Date: Jul. 27, 2006

(54) Handlebars bumper fastening means

(75) Inventor: Hsueh-Sen Liao, Hsin-Chu Hsien (TW)

Correspondence Address: TROXELL LAW OFFICE PLLC;SUITE 1404, 5205 LEESBURG PIKE, FALLS CHURCH, VA, 22041, US

(73) Assignee: Hsin Lung Accessories Co., Ltd.

(21) Appl. No.: 11/033,285

(22) Filed: Jan. 12, 2005

(51) Int. Cl. B62K 21/12

(52) U.S. Cl. 74/551.8

(57) ABSTRACT

A bike or motorcycle bumper fastening means with both ends each provided with a locking hole; a pair of clamps extending from the locking hole to clamp each end of the bumper; each clamp being adapted with a through holes aligned to each other; either clamp being provided with a secondary through hole on the opposite side where the through hole is provided for adjustment purpose to reduce the spacing between the clamp and the end of the bumper to prevent handlebars from getting deformed or loosened up due to improper clamping force as found with the prior art.

### BACKGROUND OF THE INVENTION

(a) Field of the Invention

The present invention is related to a fastening means, and more particularly to one for the handlebars bumper of a bike or a motorcycle.

(b) Description of the Prior Art

As illustrated in FIGS. 1 and 2 of the accompanying drawings for a fastening means of the prior art to secure a bump to a pair of handlebars of a bike or motorcycle, the pair of handlebars 10 are curved and made in symmetric form. To prevent the handlebars from deformation or breakage while the bike or the motorcycle is driving on rough road, a bump 20 is mounted to the handlebars 10 to reinforce the curved portion of the handlebars 10 vulnerable to stress. Wherein, both ends 21 of the bumper are each disposed with a round hole 22, a fastener 30 containing a C-shaped locking hole 31 to be inserted into the handlebars 10; and a pair of clamps 32 to hold both ends 21 of the bumper 20. Two through holes aligned to each other are respectively provided at the top of the U-shape clamps 32.

In assembling as illustrated in FIG. 3(A), both ends 21 of the bumper 20 are secured between both clamps 32 of the fastener 30. A bolt 41 penetrates through both through holes 321 and the round hole 22 and held in place by a nut 42 for the clamps 32 to secure the handlebars 10 through the locking hole 31. However, the spacing between the end 21 and the clamp 32 is comparatively greater. Accordingly, the excessive locking force from the clamp 32 upon the end 21 will cause the handlebars 10 to get deformed; or as illustrated in FIG. 3(B), with the end 21 firmly secured two clamps 32, the bolt 41 is locked by the nut 42 for both clamps 32 to firmly hold each end 21 of the bumper 20, but the fastener 30 however fails to firmly lock up the handlebars, the handlebars could get loosened up or even slip out of position to frustrate the purpose of the bumper 20.

### SUMMARY OF THE INVENTION

The primary purpose of the present invention is to provide an improved means to fasten the bumper to the handlebars for eliminating the problem of deformed handlebars due to excessive stress or displacement of the handlebars due to insufficient stress applied to the use of a single component in the prior art to operate the clamps to hold the handlebars through the locking hole and to secure both ends of the bumper at the same time.

To achieve the purpose, a round hole is disposed to each end of the bumper; a fastener adapted with a C-shaped locking hole to be inserted into the end of the handlebars; a pair of clamps extend through a gap of the locking hole to hold each end of the bumper; the pair of the clamps are each provided with a through hole; and both through holes aligned to each other. Wherein, a secondary through hole is disposed to either clamp on the side opposite to the side where the through hole is provided to accommodate an adjustment. Each end of the bumper is placed between the pair of the clamps; a bolt penetrates through both through holes and the round hole, and then is secured with a nut for the clamps to secure the end of the handlebars in the locking hole while the adjustment helps reduce the spacing between the clamps and each end of the bumper.

### BRIEF DESCRIPTION OF THE DRAWINGS

FIG. 1 is a perspective view of a fastening means for the handlebars and the bumper of the prior art.

FIG. 2 is an exploded view of the prior art.

FIGS. 3A and 3B are schematic views showing the construction of the fastening means of the prior art.

FIG. 4 is a perspective view of a first preferred embodiment of the present invention.

FIG. 5 is an exploded view of the first preferred embodiment of the present invention.

FIG. 6 is a schematic view showing the construction of the first preferred embodiment of the present invention.

FIG. 7 is a schematic view showing the construction of the second preferred embodiment of the present invention.

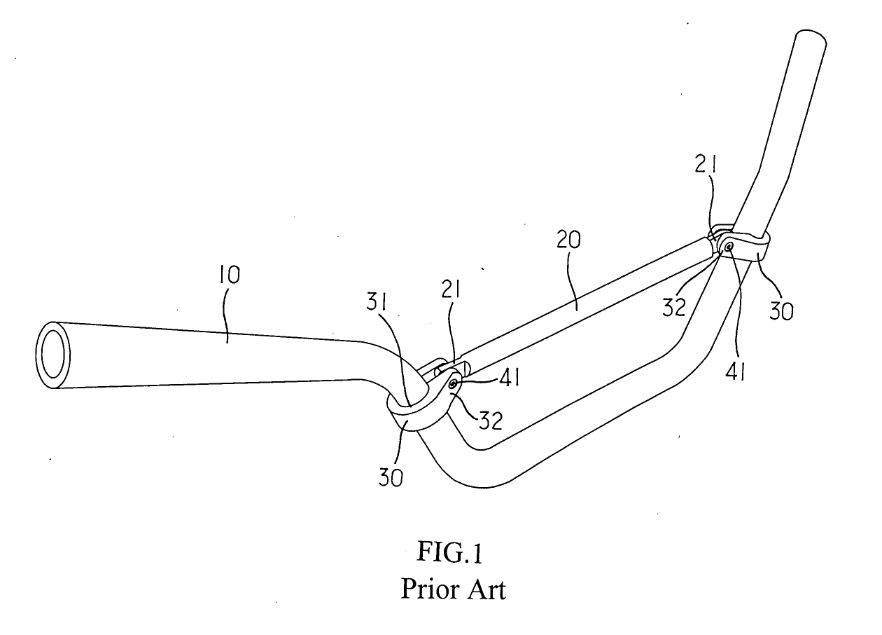

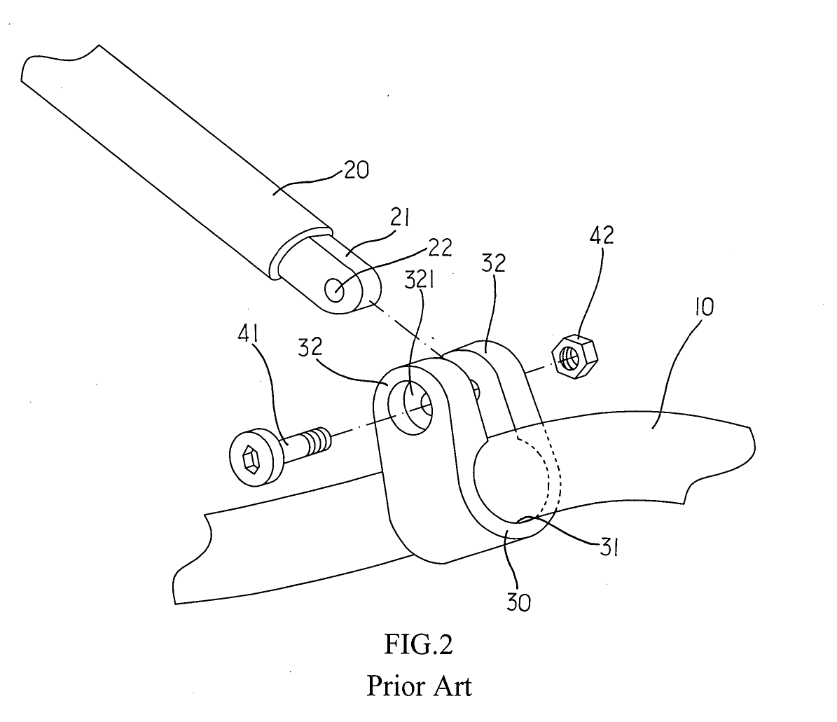

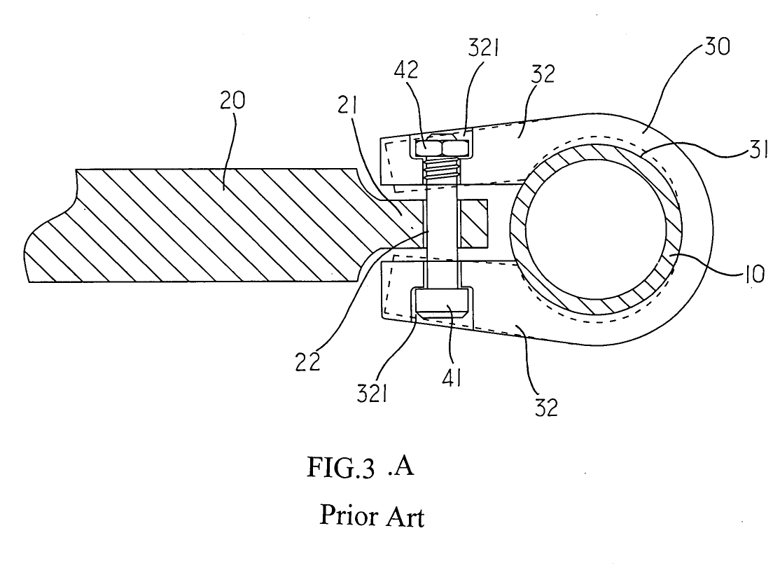

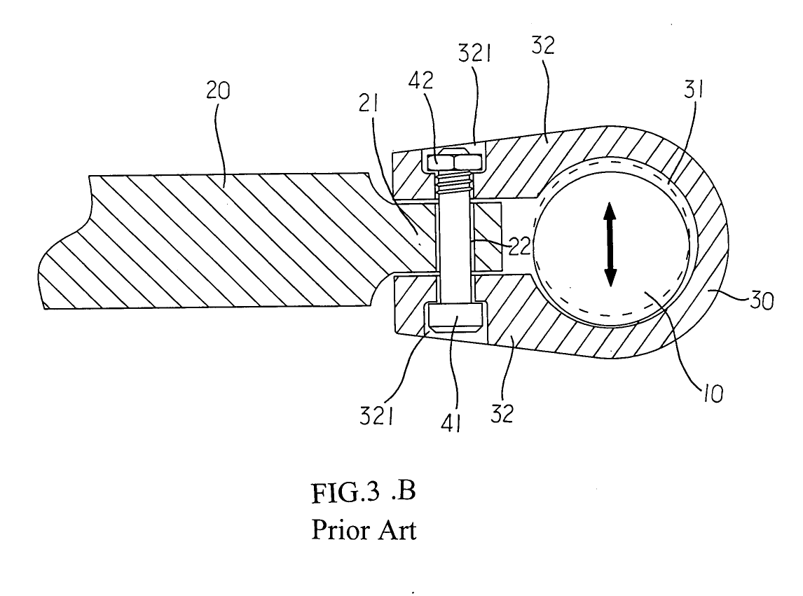

### DETAILED DESCRIPTION OF THE PREFERRED EMBODIMENTS

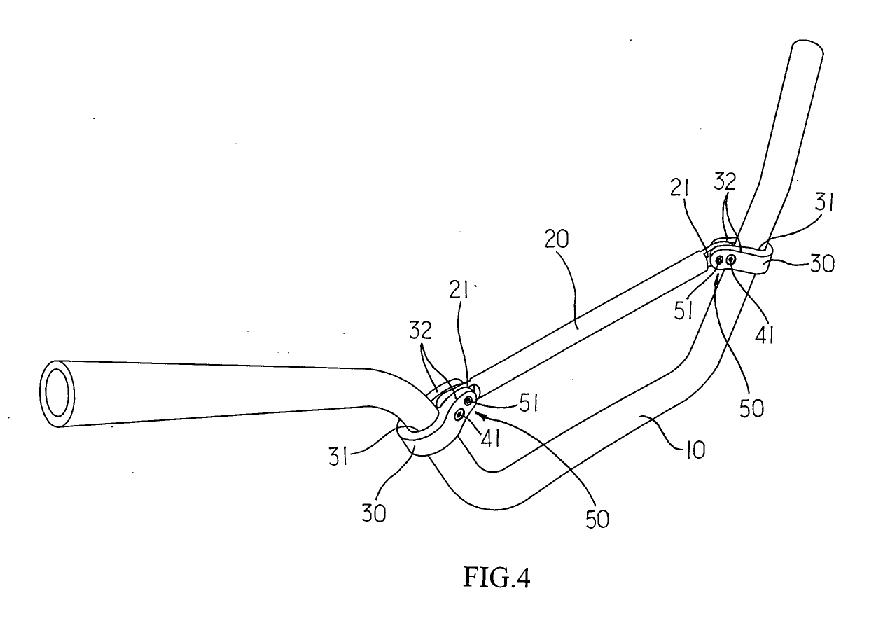

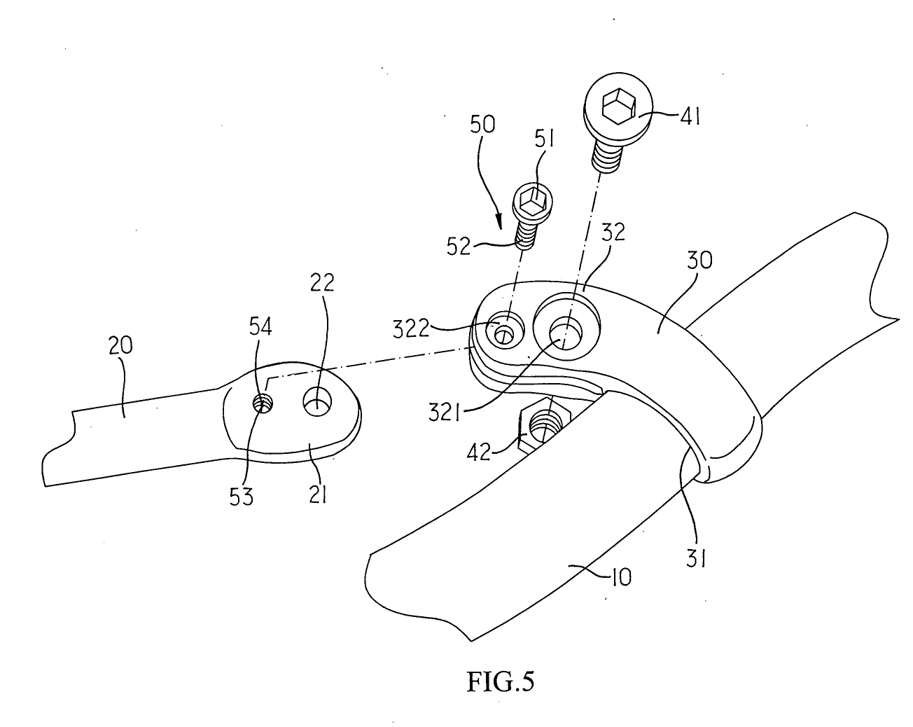

Referring to FIGS. 4 and 5, a first preferred embodiment of the present invention includes a round hole 22 is each provided on both ends 21 of a bumper 20, and a fastener 30 containing a C-shaped locking hole 31 is each provided also at both ends of the bumper 20 to be respectively inserted by a curved section of a pair of handlebars 10. A pair of clamps 32 extends from a gap of the locking hole 31 to clamp each end 21 of the bumper 20. A through hole 321 is each disposed on each clamp 32 and both through holes 321 are aligned to each other. A secondary through hole 322 is disposed on either clamp 32 on the side opposite to the side where the locking hole 31 is provided for accommodation of an adjustment 50.

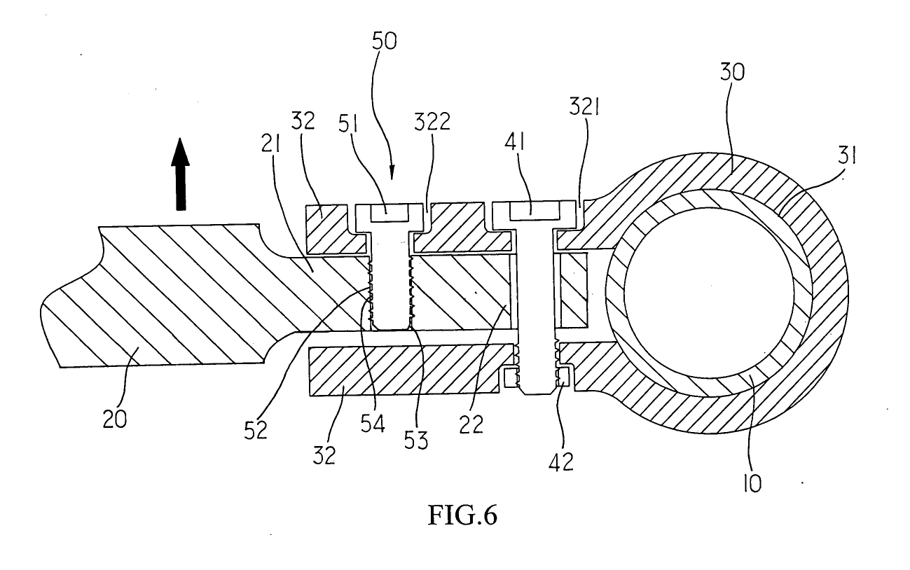

As illustrated in FIGS. 5 and 6, the adjustment 50 includes a locking member 51 containing an outer thread 52 and a threaded a secondary round hole 53 containing an inner thread 54. When assembled, both ends 21 of the bumper 20 are placed each between two clamps 322; a bolt 41 is inserted through both through holes 321 and the round hole 22; and a nut 41 locks up the bolt 42 to tighten up both clamps 32 for securing the handlebars through both locking holes 31. The locking member 51 penetrates the secondary through hole 322 and is locked in the secondary round hole 53 to connect the bumper 20 to the fastener 30. The locking achieved between the locking member 51 and the round hole 52 helps reduce the spacing between the clamps 32 and the end 21 of the bumper 20.

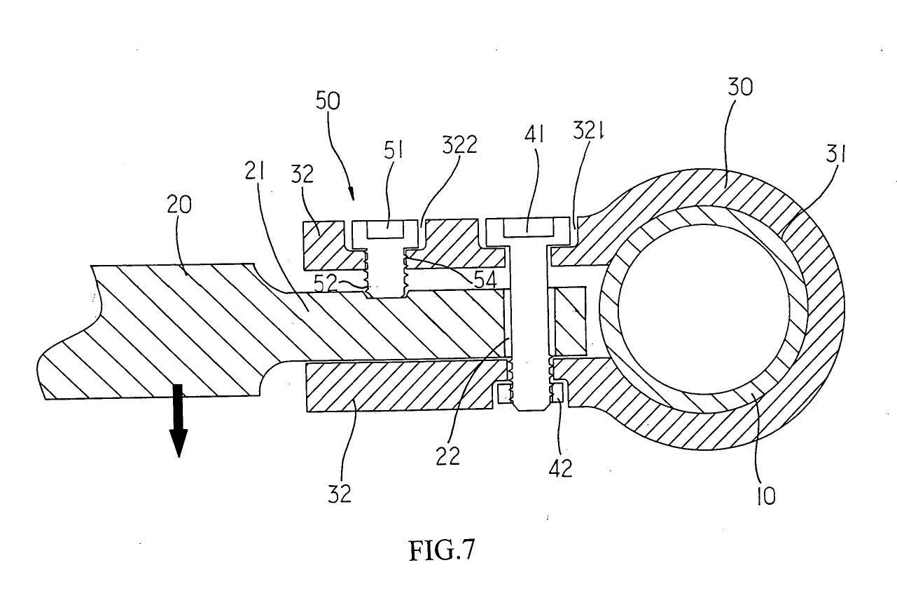

Furthermore, as illustrated in FIG. 7, in a second preferred embodiment of the present invention, the adjustment 50 is comprised of a locking member 51 containing the out thread 52 and the inner thread 54 in the secondary through hole 322. In assembly, the bolt 41 penetrates through the through holes 321 and the round hole 22 while the nut 42 and the bolt 41 are engaged to each other to tighten up both clamps 32 for securing the handlebars 10 in the locking hole 31 and the end 21 of the bumper 20 is secured in the secondary through hole 322 by the locking member 51. meanwhile, on the side where each end 21 of the bumper 20 contacts the secondary through hole 322 is further disposed with a positioning slot 211 for the side of the locking member 51 penetrating through the secondary through hole 322 to push against the positioning slot 211 at each end of the bumper 20, thus for the other side of each end 21 to contact both clamps 32.

While the handlebars 10 are locked to the bumper 20 by means of the fastener 30, the bolt 41 and the nut 42 are first used to secure the bumper 20 between two clamps 32 and the handlebars 10 in the locking hole 31, and then the adjustment 50 is used to adjust the spacing between the clamps 32 and both ends 21 of the bumper 20 for a proper tension to eliminate the deformation or loosen up handles bars due to only a single component is used to hold the clamps to secure the handlebars and both ends of the bumper through the locking hole at the same time as observed with the prior art.

The prevent invention provides an improved construction of a means to lock the bumper to the handlebars of a bike or a motorcycle, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I Claim,

1. A means to lock a bumper to a pair of handlebars of a bike or a motorcycle includes the bumper having at its both ends respectively disposed with a round hole; a fastener containing a C-shaped locking hole to be inserted by the handlebars; a pair of clamps extending from the gap of the locking hole to each hold onto both ends of the bumper; each clamp being provided with a through hole and both through holes being aligned to each other; a secondary through hole being provided to either clamp opposite on the side opposite to that where the locking hole is provided for accommodation an adjustment; both ends of the bumper being placed between both clamps; a bolt penetrating through both through holes and the round hole; a nut and the bolt being engaged to each other to tighten up the clamps to secure the handlebars in the locking hole; and the adjustment helping reducing the spacing between the clamps and both ends of the bumper.

2. The means to lock a bumper to a pair of handlebars of a bike or a motorcycle of claim 1, wherein the adjustment is comprised of a locking member provided with an outer thread and a secondary round hole containing an inner thread being disposed on each end of both ends of the bumper; and the locking member penetrating through both secondary through holes and locked in the secondary round hole.

3. The means to lock a bumper to a pair of handlebars of a bike or a motorcycle of claim 1, wherein the adjustment relates to a locking member provided with an out thread, and an inner thread disposed in the secondary through hole; the locking member being locked in the secondary through hole; and one side of the locking member penetrating through the secondary through hole pushing against each end of the bumper.

4. The means to lock a bumper to a pair of handlebars of a bike or a motorcycle of claim 3, wherein a positioning slot is provided on the side where each end of the bumper contacts the secondary through hole.
